(19) United States
(12) Patent Application Publication
(10) Pub. No.: US 2026/0331978 A1
(43) Pub. Date: Oct. 22, 2026

(54) ROTARY ELECTRIC MACHINE

(71) Applicant: MITSUBISHI ELECTRIC MOBILITY CORPORATION, Tokyo (JP)

(72) Inventors: Shinsuke KAYANO, Tokyo (JP); Hitoshi ISODA, Tokyo (JP); Takayuki IIDA, Tokyo (JP)

(73) Assignee: MITSUBISHI ELECTRIC MOBILITY CORPORATION, Tokyo (JP)

(21) Appl. No.: 19/111,432

(22) PCT Filed: Oct. 17, 2022
(86) PCT No.: PCT/JP2022/038543

§ 371 Date: Mar. 13, 2025

(51) Int. Cl. H02K 1/276; H02K 1/16

(52) U.S. Cl. CPC H02K 1/2766; H02K 1/16

(57) ABSTRACT

In a rotating electric machine in which the number of slots for each pole and each phase is four or more and the armature winding is configured as a distributed winding, a flux barrier is formed adjacent to each circumferential end of a first permanent magnet composing each magnetic pole, and a central angle θ1 of a first arc portion composing the outer peripheral surface on the radially outer side of a rotor core where no flux barrier is formed between circumferentially adjacent magnetic poles with respect to the center of rotation O is configured to ensure a first condition that θ1=P1×2.1 or less, where P1 is the central angle of the arc connecting the circumferential centers of circumferentially adjacent slots.

### TECHNICAL FIELD

The present disclosure relates to a rotary electric machine

### BACKGROUND ART

In rotary electric machines such as motors and generators for EV (Electric Vehicle)/HEV (Hybrid Electric Vehicle), there is a demand for miniaturization, high efficiency, and low NV (Noise Vibration) from the viewpoints of resource saving, extending the vehicle's driving range, quietness, etc. Conventionally, in order to realize NV reduction, a traction motor as a rotary electric machine as described below has been disclosed, which suppresses magnetic flux fluctuations in the air gap between the stator and rotor by making the stator have a multi-slot structure, thereby reducing torque ripple, cogging torque, etc.

That is, in a traction motor as a conventional rotary electric machine, a first plurality of magnet pairs are configured in a laminate stack, and arranged in a first V-shaped configuration. Also, a second plurality of permanent magnets larger than each of the first plurality of permanent magnets are configured as a second plurality of magnet pairs in the laminate stack, and arranged in a second V-shaped configuration. The separation angle of the second magnet pairs is configured to be smaller than the separation angle of the first magnet pairs (see, for example, Patent Document 1).

### CITATION LIST

### Patent Document

Patent Document 1: Japanese Laid-Open Patent Publication No. 2020-68654 (FIG. 3, FIG. 4)

### SUMMARY OF THE INVENTION

### Problem to be Solved by the Invention

In the above-mentioned conventional traction motor, a method has been proposed in which a multi-slot structure with four slots for each pole and each phase of the stator is adopted, and the size and arrangement angle of the permanent magnets embedded in the rotor as a laminated stack, are adjusted to reduce the cogging torque. However, although such a motor can reduce the cogging torque, it may lead to an increase in stator iron loss and reduce the motor efficiency. In particular, in a multi-slot structure with a large number of slots for each pole and each phase, the number of teeth between the magnetic poles of the rotor increases, resulting in a problem that the increase in the aforementioned iron loss becomes large and the motor efficiency decreases. The present disclosure has been made to solve the above problem, and an object of the present disclosure is to provide a rotary electric machine that is highly efficient even in a multi-slot structure with a large number of slots for each pole and each phase.

### Means to Solve the Problem

A rotary electric machine according to the present disclosure comprises:

a stator having a plurality of teeth protruding to an inner side in a radial direction from an annular yoke portion, and armature windings wound in a plurality of slots formed between the teeth; and

a rotor including a rotor core having a plurality of magnetic poles and flux barriers, the poles being formed of permanent magnets, wherein

in the rotary electric machine, the number of the slots for each phase and each pole obtained by dividing a total number of slots by a number of phases and a number of the magnetic poles of the rotor is four or more, and the armature winding is configured as distributed winding, and wherein:

a first flux barrier as the flux barrier is formed adjacent to each circumferential end of a first permanent magnet composing each of the magnetic poles;

a central angle θ1 of a first arc portion composing an outer peripheral surface on an outer side in a radial direction of the rotor core, where flux barrier is not formed between magnetic poles adjacent in the circumferential direction, is configured to ensure a first condition of θ1=P1×2.1 or less.

Where P1 is a central angle of an arc connecting the circumferential centers of circumferentially adjacent slots.

### Effect of the Invention

The rotary electric machine according to the present disclosure makes it possible to provide the rotary electric machine with a high efficiency, even having a configuration of a multi-slot structure having a large number of slots for each pole and each phase.

### BRIEF DESCRIPTION OF THE DRAWINGS

FIG. 1 is a schematic diagram showing a cross section parallel to an axial direction in a rotary electric machine according to an embodiment 1.

FIG. 2 is a diagram showing a portion of a cross section perpendicular to an axial direction in the rotary electric machine according to an embodiment 1.

FIG. 3 is a cross-sectional view perpendicular to the axial direction Y of a rotary electric machine of the comparative example.

FIG. 4 is a cross-sectional view perpendicular to the axial direction Y of a rotary electric machine of the comparative example.

FIG. 5 is a cross-sectional view perpendicular to the axial direction Y of a rotary electric machine of the comparative example.

FIG. 6 is a graph showing the iron loss characteristics of a rotary electric machine when the central angle θ1 is changed.

FIG. 7 is a diagram explaining the principle of iron loss increase in a rotary electric machine.

FIG. 8 is a diagram showing a part of a cross-section perpendicular to the axial direction of the rotary electric machine according to embodiment 1.

FIG. 9 is a cross-sectional view perpendicular to the axial direction Y of a rotary electric machine of the comparative example.

FIG. 10 is a cross-sectional view perpendicular to the axial direction Y of a rotary electric machine of the comparative example.

FIG. 11 is a cross-sectional view perpendicular to the axial direction Y of a rotary electric machine of the comparative example.

FIG. 12 is a graph showing the iron loss characteristics of the rotary electric machine when the central angle θ2 is changed.

FIG. 13 is a diagram explaining the principle of iron loss increase in the rotary electric machine.

FIG. 14 is a diagram showing a graph of torque characteristics in the rotary electric machine.

FIG. 15 is a diagram showing a portion of a cross section perpendicular to the axial direction in the rotary electric machine according to embodiment 1.

FIG. 16 is a diagram showing a portion of a cross section perpendicular to the axial direction in a rotary electric machine according to embodiment 2.

FIG. 17 is a diagram showing a portion of a cross section perpendicular to the axial direction in the rotary electric machine according to embodiment 2.

FIG. 18 is a diagram showing a portion of a cross section perpendicular to the axial direction in the rotary electric machine according to embodiment 2.

FIG. 19 is a diagram showing a portion of a cross section perpendicular to the axial direction in the rotary electric machine according to embodiment 2.

FIG. 20 is a diagram showing a portion of a cross section perpendicular to the axial direction in the rotary electric machine according to embodiment 2.

FIG. 21 is a diagram showing a portion of a cross section perpendicular to the axial direction in the rotary electric machine according to embodiment 2.

FIG. 22 is a diagram showing magnetomotive force distribution in the rotary electric machine.

FIG. 23 is a diagram showing magnetomotive force distribution in the rotary electric machine.

### DESCRIPTION OF EMBODIMENTS

### Embodiment 1

Hereinafter, a rotary electric machine according to embodiment 1 of the present invention will be described with reference to the drawings.

In the drawings, the directions in the annular rotary electric machine are indicated as the circumferential direction C, the radial direction X, and the axial direction Y.

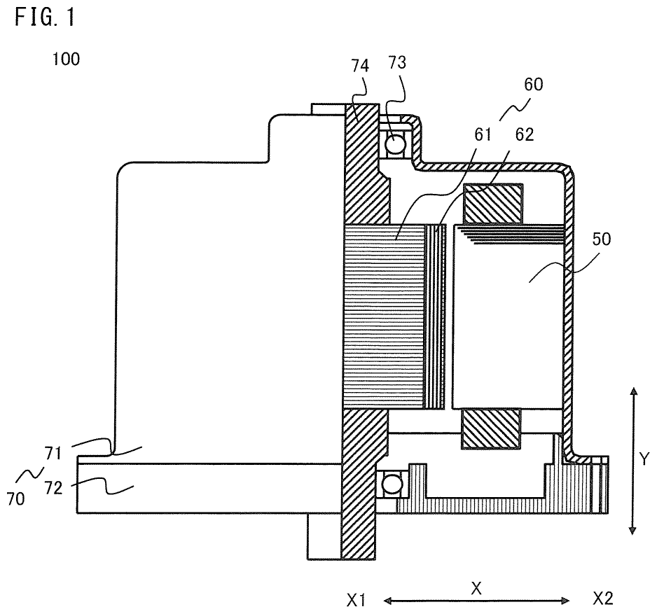

FIG. 1 is a schematic diagram showing a cross section parallel to the axial direction Y in the rotary electric machine 100 according to the embodiment 1.

As shown in FIG. 1, the rotary electric machine 100 includes a cylindrical housing 70, a stator 50 accommodated therein, and a rotor 60 arranged coaxially with the stator 50 on the radial inside X1 of the stator 50.

The housing 70 includes a cylindrical frame 71 with a bottom and an end plate 72 that closes an opening of the frame 71.

The stator 50 is fixed to the frame 71 in a state of being fitted inside the frame 71 of the radial inside X1.

The rotor 60 is rotatably supported by a rotating shaft 74 provided via a bearing 73 at the center of the end plate 72 of the frame 71.

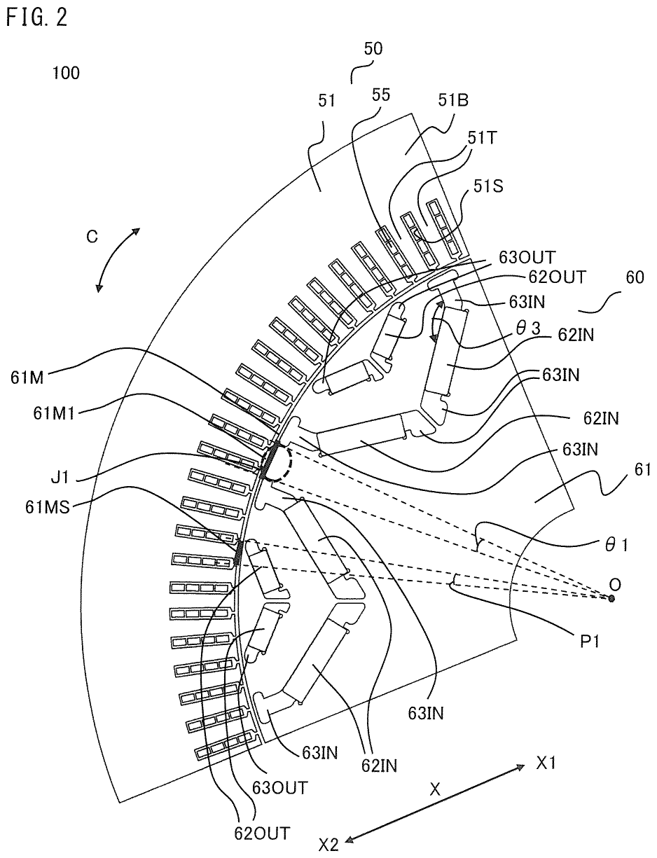

FIG. 2 is a diagram showing a part of a cross section perpendicular to the axial direction in the rotary electric machine 100 according to the embodiment 1. This figure shows only a portion corresponding to about ¼ of the circumference of the annular rotary electric machine 100. As shown in FIG. 2, the stator 50 has a stator core 51 formed by laminating electromagnetic steel sheets, and three-phase coils 55 of U, V, and W as armature windings wound around the stator core 51.

The stator core 51 has an annular core back 51B, a plurality of teeth 51T extending from the core back 51B towards the radial inside X1, and a plurality of groove-shaped slots 51S formed by being surrounded by adjacent teeth 51T and the core back 51B. Coils 55 are accommodated in these slots 51S.

In the stator 50 of this embodiment, 96 slots 51S are formed at equal intervals in the circumferential direction C. Here, if the central angle of arc 61 MS connecting the circumferential centers of circumferentially adjacent slots 51S with respect to center point θof rotor 60 is P1, then this central angle P1 is 360°/96=3.75°. The connection method of coils 55 is distributed winding, and the coils 55 in each slot 51S are connected to each other in series or in parallel.

The rotor 60 has an annular rotor core 61 as a rotor core, and permanent magnets 62 (62IN, 62OUT) that compose each magnetic pole formed at set intervals in the circumferential direction of the rotor core 61. The permanent magnets 62 (62IN, 62OUT) are embedded in magnet insertion holes in the rotor core 61.

Each magnetic pole has a two-layer structure in which a pair of permanent magnets 62IN as first permanent magnets is arranged on the radial inside X1, and a pair of permanent magnets 62OUT as second permanent magnets is arranged on the radial outside X2, with four permanent magnets 62 embedded for each pole.

The pair of permanent magnets 62IN, 62OUT are each arranged in a V-shape that opens out toward the outer circumferential surface 61M of the rotor 60.

In the rotor core 61, flux barriers for preventing leakage of magnetic flux from the permanent magnets 62 are formed adjacent to both ends of the permanent magnets 62. That is, the permanent magnets 62IN are formed with flux barriers 63IN as first flux barrier so as to communicate with both ends of the magnet insertion hole, and the permanent magnets 62OUT are formed with flux barriers 63OUT as second flux barrier so as to communicate with both ends of the magnet insertion hole.

The flux barriers 63IN are formed to extend from both ends of the permanent magnets 62IN in the circumferential direction C toward the radially outer side direction X2 with an extension angle θ3 set with respect to the permanent magnets 62IN.

In this embodiment, the rotor 60 has 8 magnetic poles, and the number of slots q for each pole and each phase, calculated by dividing the total number of slots 96 by the number of phases 3 and the number of magnetic poles 8, is 96/(8*3)=4. The larger the number of slots q for each pole and each phase, the more multi-slot configuration the stator 50 will have.

In this way, in a rotary electric machine 100 with a multi-slot structure, the number of slots 51S that face the outer circumferential surface 61M of the rotor core 61 between adjacent magnetic poles in the circumferential direction C increases.

As shown in FIG. 2, the region of the rotor core 61 between adjacent magnetic poles in the circumferential direction C where no flux barrier is formed near the outer circumferential surface 61M is defined as J1, and the arc that composes the outer circumferential surface 61M on the radial outside X2 of this region J1 is defined as a first arc portion 61M1.

If the central angle of this first arc portion 61M1 with respect to the center of rotation θof the rotor 60 is θ1, in this embodiment, the central angle θ1 is configured to ensure a first condition that θ1=P1×2.1 or less.

The vicinity of the outer peripheral surface 61M of the rotor core 61 refers to an area within a set range X1 radially inward from the outer peripheral surface 61M, and this set range is set according to the range in which magnetic flux short-circuits in the magnetic path from teeth 51T→between magnetic poles→teeth 51T, which will be described later, occurs.

The effect of setting the central angle θ1 of the first arc portion 61M1 with respect to the center of rotation 0 to be equal to or less than P1×2.1 will now be described using experimental results using a motor as a comparative rotary electric machine in which the value of θ1 is changed.

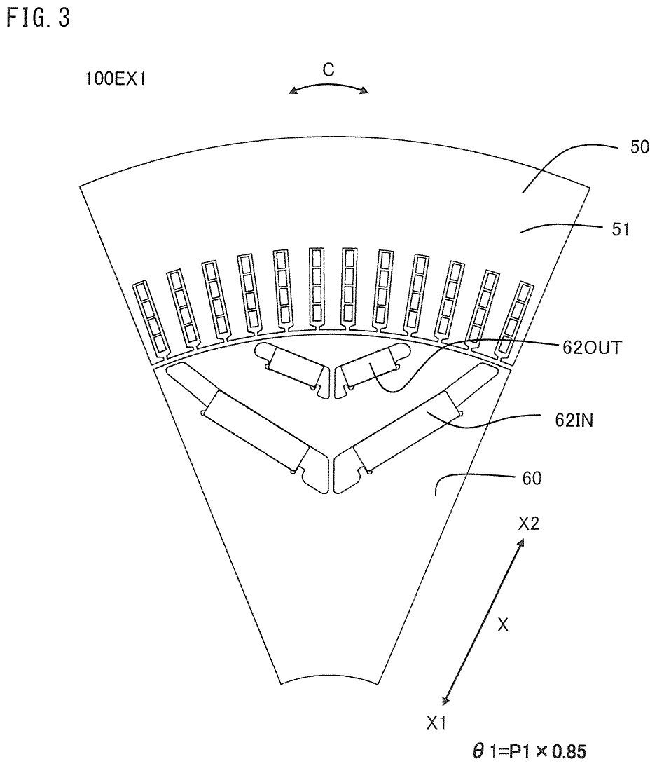

FIG. 3 is a cross-sectional view perpendicular to the axial direction Y of the rotary electric machine 100EX1 of the comparative example when θ1=P1×0.85.

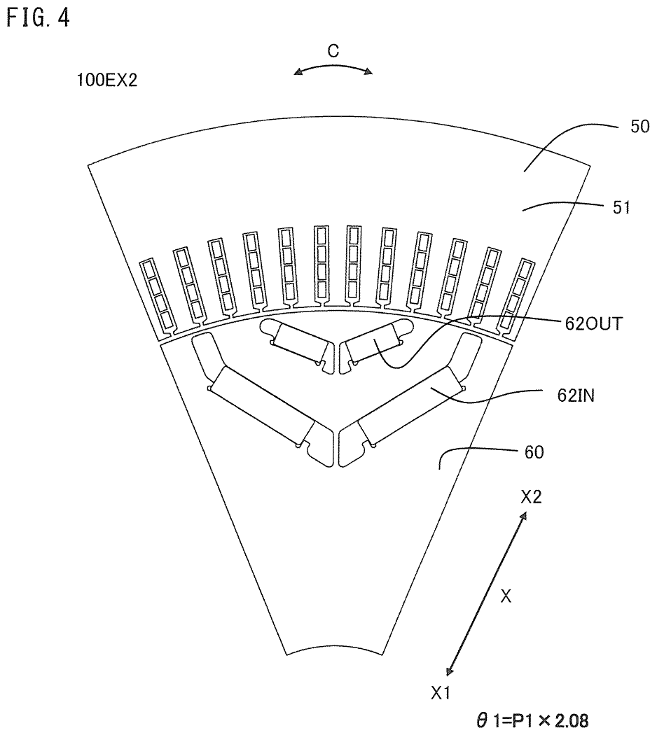

FIG. 4 is a cross-sectional view perpendicular to the axial direction Y of the rotary electric machine 100EX2 of the comparative example when θ1=P1×2.08.

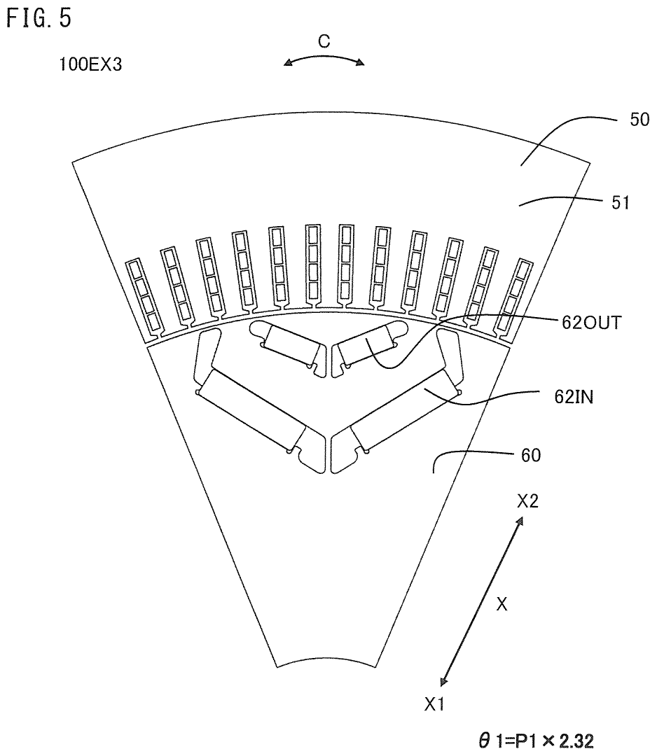

FIG. 5 is a cross-sectional view perpendicular to the axial direction Y of the rotary electric machine 100EX3 of the comparative example when θ1=P1×2.32.

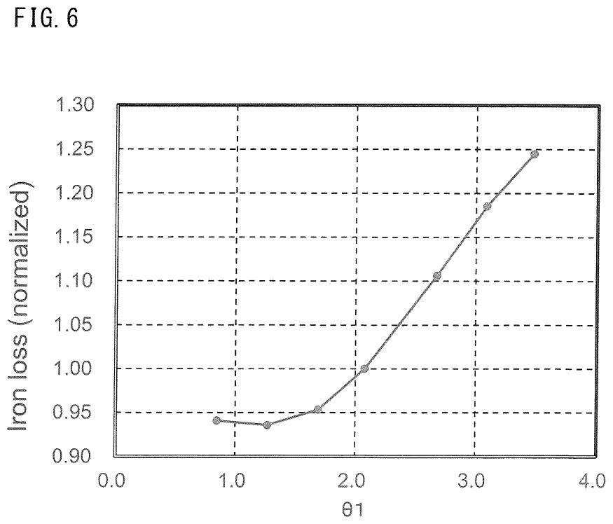

FIG. 6 is a graph showing the iron loss characteristics of a rotary electric machine when the central angle θ1 is changed.

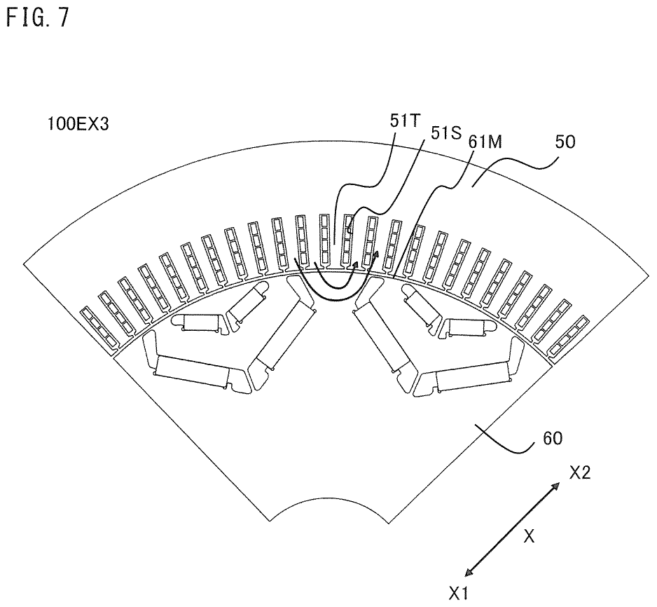

FIG. 7 is a diagram explaining the principle of iron loss increase in a rotary electric machine.

Since efficiency in the medium speed and low load ranges when driving in urban areas is important for motors for electric vehicles as rotary electric machines, electromagnetic field analysis was performed using each of the rotary electric machines 100EX1, EX2, and EX3 and rotary electric machines with central angle θ1 values other than these rotary electric machines 100EX1, EX2, and EX3 under conditions of low current and current phase of 90°.

In FIG. 6, the iron loss is normalized under the condition θ1=P1×2.08.

From FIG. 6, it can be seen that the inflection point where the change in iron loss with respect to the central angle θ1 changes sharply is at θ1=P1×2.08. This is because, when the number of slots 51S of the stator 50 facing the first arc portion 61M1 that forms the central angle θ1 increases, the magnetic flux that short-circuits in the magnetic path from the teeth 51T→between the magnetic poles-the teeth 51T increases through the area where no flux barrier is formed near the outer circumferential surface 61M of the rotor core 61, as shown by the arrow in FIG. 7, and the magnetic flux density in the teeth 51T increases, leading to an increase in stator iron loss. Therefore, if the central angle θ1 that forms the first arc portion 61M1 is configured to satisfy the first condition of setting it to 2.1 times or less than P1, it is possible to reduce stator iron loss and increase the efficiency of the rotary electric machine.

Here, even if the central angle θ1 is the same between a rotary electric machine with the number of slots for each pole and each phase q=2 and a rotary electric machine with q=4, the number of slots 51S facing the first arc portion 61M1 in the q=4 rotary electric machine is twice as large as that in the q=2 rotary electric machine. Although the increased number of slots suppresses the fluctuation of the magnetic flux in the air gap between the stator and the rotor, and reduces the torque ripple and the cogging torque, the iron loss increases if the number of slots facing the first arc portion 61M1 is large. In particular, if a rotor designed for a stator with q=2 to 3 slots per phase, which is typical for motors for electric vehicles, is applied to a stator with q=4 or more without changing the configuration, there is a high possibility that the iron loss will increase due to the principle described above. In the rotary electric machine of this embodiment, even if the rotary electric machine has a multi-slot configuration, the central angle θ1 is designed to ensure the first condition as described above, so that both the quieting effect due to the reduction in torque ripple due to the increased number of slots and the high efficiency due to the reduction in stator iron loss can be obtained.

Furthermore, the rotary electric machine may have the following configuration.

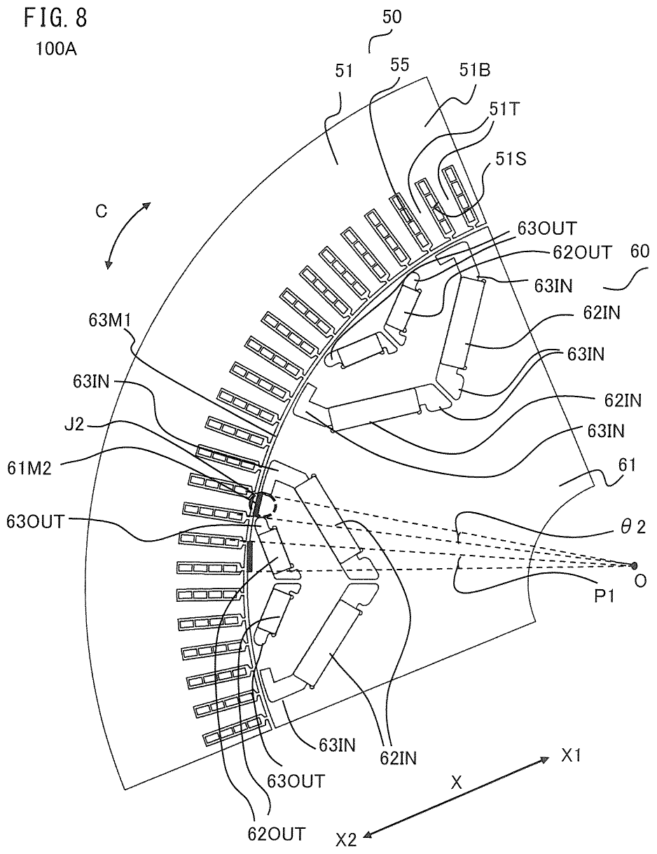

FIG. 8 is a diagram showing a part of a cross section perpendicular to the axial direction of the rotary electric machine 100A according to the embodiment 1, and shows only a portion corresponding to about ¼ of the circumference of the annular rotary electric machine 100A.

In each magnetic pole, the region of the rotor core 61 between the flux barrier 63IN and the flux barrier 63OUT in the vicinity of the outer peripheral surface 61M where no flux barrier is formed is defined as J2, and the arc constituting the outer peripheral surface 61M on the radially outer side X2 of this region J2 is defined as the second arc portion 61M2.

Note that the vicinity of the outer peripheral surface 61M of the rotor core 61 refers to the region within a set range from the outer peripheral surface 61M to the radially inner side X1, and this set range is set according to the range in which magnetic flux short-circuiting in the magnetic path between the magnet layers→stator 50→between the magnetic poles, which will be described later. If the central angle of this second arc portion 61M2 with respect to the center of rotation 0 is θ2, in this embodiment, the central angle θ2 is configured to ensure the first condition of θ2=P1×1.65 or less.

The effect of setting the central angle θ2 of the second arc portion 61M2 with respect to the center of rotation 0 to P1×1.65 or less will now be described using experimental results using a motor as a comparative rotary electric machine in which the value of θ2 is changed.

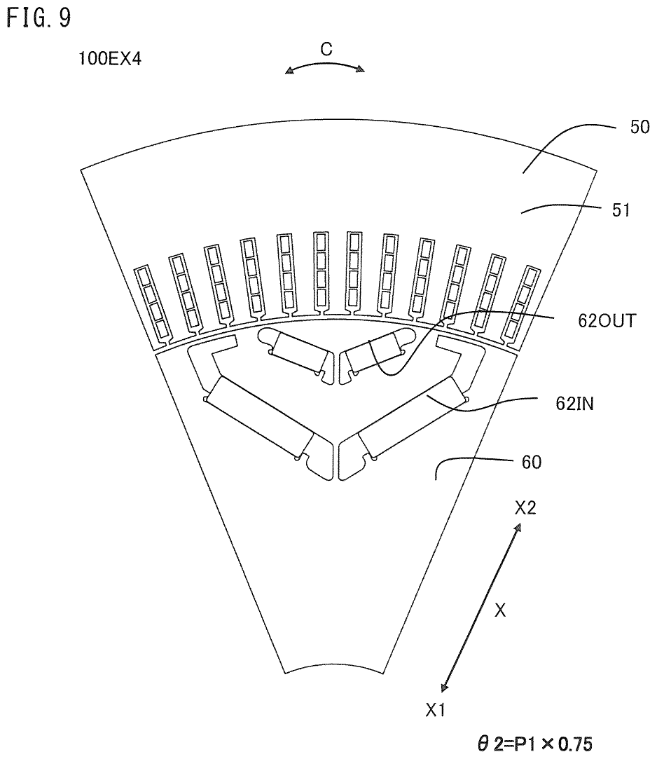

FIG. 9 is a cross-sectional view perpendicular to the axial direction Y of the comparative rotary electric machine 100EX4 when θ2=P1×0.75.

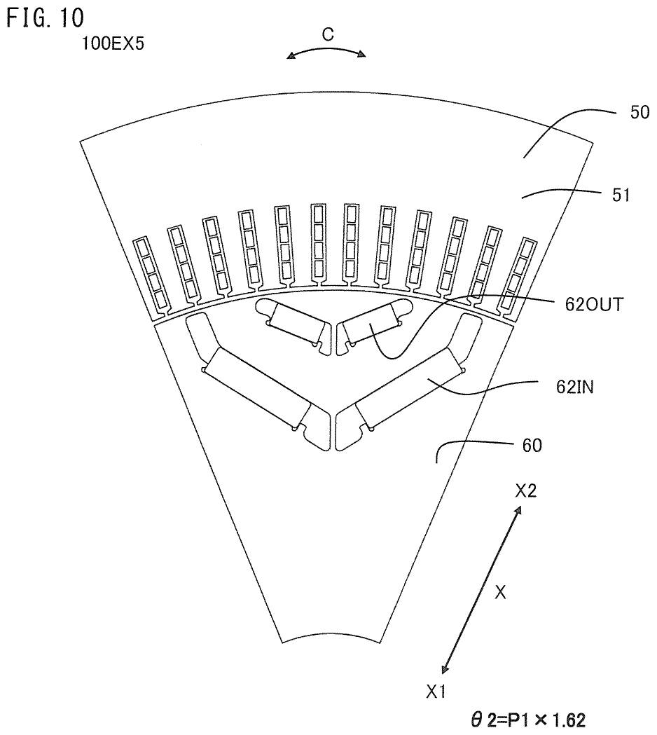

FIG. 10 is a cross-sectional view perpendicular to the axial direction Y of the comparative rotary electric machine 100EX5 when θ2=P1×1.62.

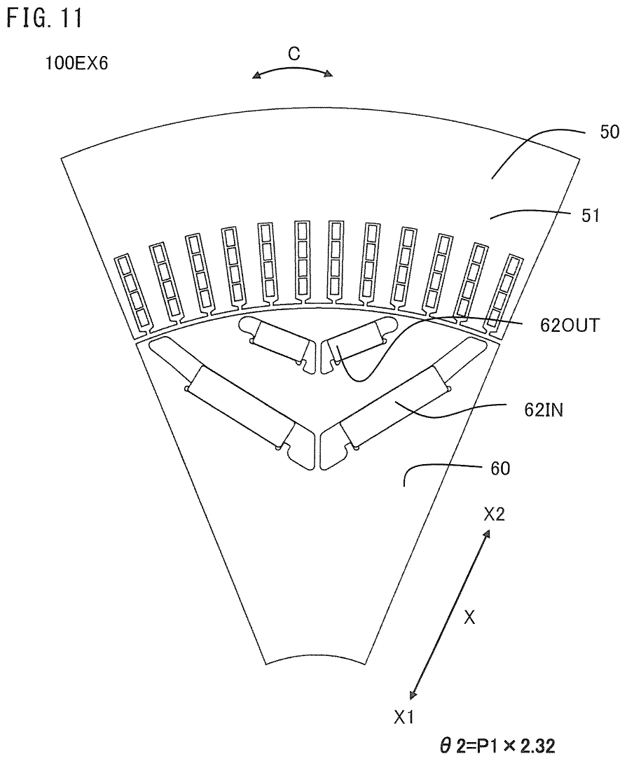

FIG. 11 is a cross-sectional view perpendicular to the axial direction Y of the comparative rotary electric machine 100EX6 when θ2=P1×2.32.

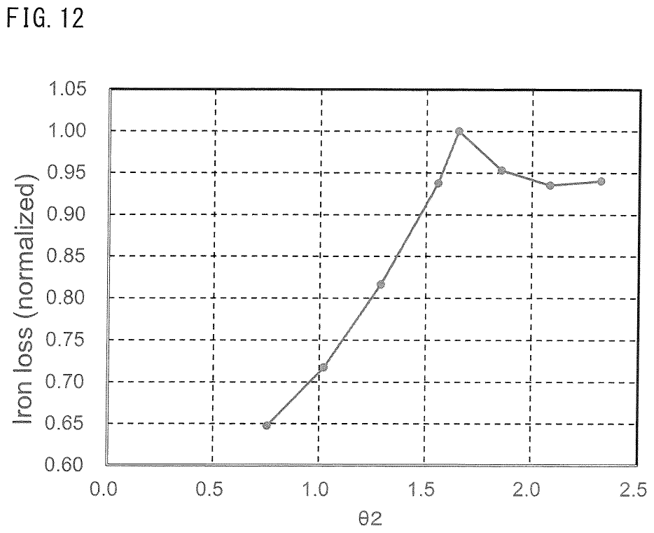

FIG. 12 is a graph showing the iron loss characteristics of a rotary electric machine when θ2 is changed.

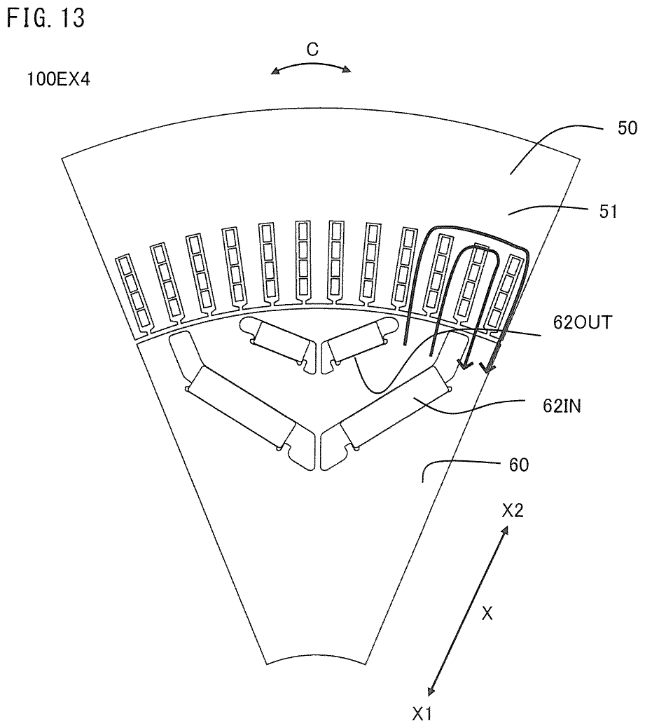

FIG. 13 is a diagram explaining the principle of iron loss increase in a rotary electric machine.

As with the case where θ1 was changed above, electromagnetic field analysis was performed using each of the rotary electric machines 100EX4, EX5, and EX6 under conditions of low current and current phase of 90°. θ2 was changed for analysis while maintaining the first condition that θ1 is equal to or less than P1×2.1.

In FIG. 12, iron loss is normalized under the condition θ2=P1×1.62.

It can be seen from FIG. 12 that the iron loss of the motor drops sharply with respect to the central angle θ2 in the region where the central angle θ2 is equal to or less than P1×1.65. This is because, when the number of slots 51S of the stator 50 facing the second arc portion 61M2 that forms the central angle θ2 increases, the magnetic flux short-circuiting, between the magnet layers→the stator 50→between the magnetic poles, increases as shown by the arrows in FIG. 13, and the magnetic flux density in the teeth 51T increases, which leads to an increase in stator iron loss. Therefore, the first condition is ensured, in which the central angle θ2 that forms the second arc portion 61M2 is set to 1.65 times P1 or less. In this way, the magnetic resistance of the above path is increased and the magnetic flux that is concentrated in a specific tooth of the stator is dispersed, thereby alleviating the local concentration of the magnetic flux density in the teeth, reducing stator iron loss, and enabling a high efficiency rotary electric machine.

Above, the iron loss characteristics when θ2 is changed are explained, however below, the torque characteristics when θ2 is changed are explained.

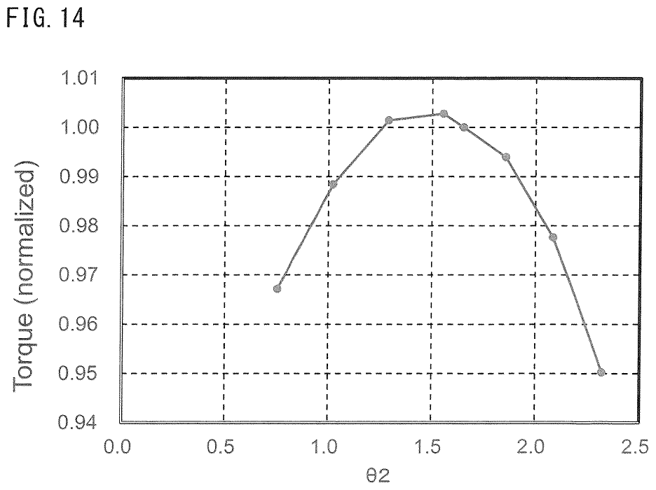

FIG. 14 is a graph showing the torque characteristics of a rotary electric machine when θ2 is changed while the first condition of θ2 being P1×1.65 or less is ensured.

As mentioned above, the magnetic resistance can be increased by reducing the central angle θ2, that is, by shortening the length of the second arc portion 61M2. However, making the central angle θ2 extremely small leads to a torque reduction, as shown in FIG. 14.

Therefore, by configuring the central angle θ2 to be greater than or equal to θ1=P1×1 while ensuring the first condition of being less than or equal to P1×1.65, it is possible to minimize the torque reduction, that is, to suppress the torque reduction to 1% or less compared to a rotary electric machine configured as the standard θ2=P1×1.62, while achieving high efficiency of the rotary electric machine.

The rotary electric machine may also be configured as described below.

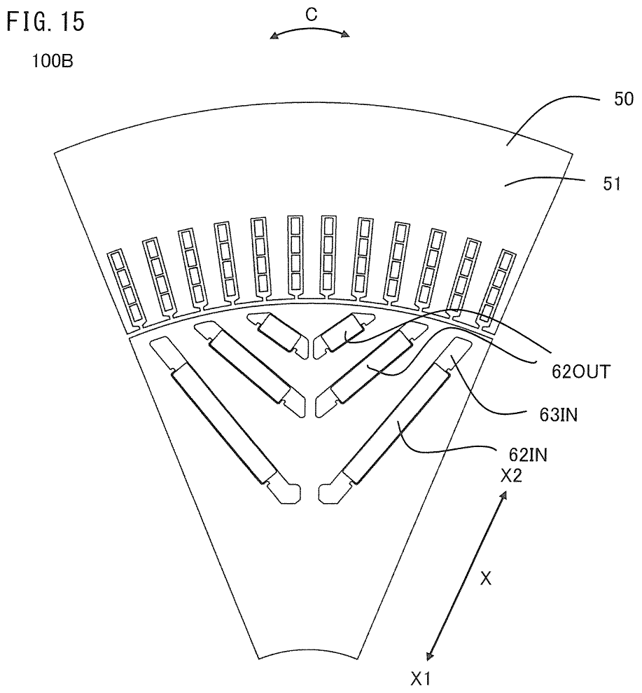

FIG. 15 is a diagram showing a portion of a cross section perpendicular to the axial direction of rotary electric machine 100B according to embodiment 1.

In the rotary electric machine 100 shown in FIG. 2, each magnetic pole has a two-layer structure with a pair of permanent magnets 62IN as the first permanent magnet composing the first layer and a pair of permanent magnets 62OUT as the second permanent magnet composing the second layer.

In the rotary electric machine 100B shown in FIG. 15, the magnetic pole has a total of three layers with a pair of permanent magnets 62IN as the first permanent magnet composing the first layer and two more layers of a pair of permanent magnets 62OUT as the second permanent magnet.

The effect of making each magnetic pole multi-layered in the radial direction will be explained.

In a two-layer structure in which the magnetic poles are arranged in two layers in the radial direction, it is possible to bring the magnetic circuit in the rotor closer to an arrangement along the excitation magnetic flux of the stator. This makes it possible to effectively utilize the reluctance torque, and improves the torque. In addition, the two-layer structure can relatively reduce the number of magnets used among multi-layer arrangements that can effectively utilize the reluctance torque, so the number of magnets inserted during rotor manufacture can be reduced, leading to reduced manufacturing costs.

However, with a two-layer magnetic pole configuration, the number of magnet layers used is small, so θ1 or θ2 tends to be large. For example, if a rotor with two-layer magnetic poles and eight poles designed for 24 slots (q=1), 48 slots (q=2), or 72 slots (q=3) with q=less than 4 is used for 96 slots (q=4), it is likely to lead to an increase in iron loss due to insufficient consideration given to the value of P1 for θ1 or θ2. In such a configuration, a rotary electric machine 100B as shown in FIG. 15 is effective.

Increasing the number of layers of the magnetic poles from a two-layer configuration to a three-layer configuration increases the freedom of the magnetic pole shape, making it possible to make more effective use of the reluctance torque and improving the torque.

The pair of permanent magnets constituting each layer of the magnetic poles is not limited to a V-shape expanding toward the outer periphery of the rotor, and may be arranged in a flat or V-shaped configuration, and the shape and number of magnet insertion holes and the shape and number of permanent magnets are not important.

For example, in a rotor having magnetic poles arranged in a flat plate configuration, the central angle θ1 of the first arc portion constituting the outer periphery of the rotor core in the radial direction where no flux barrier is formed is configured to ensure the first condition between magnetic poles each having only one permanent magnet as the first permanent magnet.

Although a configuration of 8 poles and 96 slots is shown, the above effect can be obtained even if the number of poles and slots are not limited to this. Also, q is a number equal to or greater than 4, and is not limited to an integer. The flux barrier is intended to suppress leakage of magnetic flux, and may be made of a material with a lower relative permeability than electromagnetic steel sheet, such as air or resin.

Motors for electric vehicles are required to have high output, so most motors have an outer diameter of φ150 to φ300 mm due to the constraints of the vehicle's mounting space and the requirements for torque and output density.

When designing a motor with a diameter of φ150 mm or more and high output, it is desirable to select six or more poles for the rotor, as explained below.

The optimal split ratio (outer diameter of rotor core/outer diameter of stator core) for high torque and high output design of a motor must be secured at approximately 60 to 80%. The smaller the number of poles, the larger the pole pitch (the central angle relative to the arc length of the rotor core per pole) becomes, and the amount of magnetic flux flowing through the core back of the stator increases.

The core back must be designed to be thick in order to avoid magnetic saturation of the core back, but if the number of poles is reduced, the proportion of the core back thickness in the radial length of the motor increases, making it impossible to secure a split ratio of 60 to 80%. Therefore, in motors for electric vehicles, a design with fewer than four poles should be avoided, and a configuration with six or more poles is preferable.

In adjusting θ1 to ensure the first condition, for example, the extension angle θ3 of the flux barrier 63IN shown in FIG. 2 may be adjusted, or, as shown in FIG. 2, the end of the flux barrier 63IN on the radially outer side X2 may be formed to extend along the outer peripheral surface 61M of the rotor core 61.

The rotary electric machine of the present embodiment configured as described above comprises:
a stator having a plurality of teeth protruding to an inner side in a radial direction from an annular yoke portion, and armature windings wound in a plurality of slots formed between the teeth; and
a rotor including a rotor core having a plurality of magnetic poles and flux barriers, the poles being formed of permanent magnets, wherein
in the rotary electric machine, the number of the slots for each phase and each pole obtained by dividing a total number of slots by a number of phases and a number of the magnetic poles of the rotor is four or more, and the armature winding is configured as distributed winding, and wherein:
a first flux barrier as the flux barrier is formed adjacent to each circumferential end of a first permanent magnet composing each of the magnetic poles;
a central angle θ1 of a first arc portion composing an outer peripheral surface on an outer side in a radial direction of the rotor core, where flux barrier is not formed between magnetic poles adjacent in the circumferential direction, is configured to ensure a first condition of θ1=P1×2.1 or less.
Where P1 is a central angle of an arc connecting the circumferential centers of circumferentially adjacent slots.

This makes it possible to provide a highly efficient rotary electric machine even in a multi-slot structure with a large number of slots for each pole and each phase.

Furthermore, in the rotary electric machine of this embodiment configured as described above, the magnetic poles is configured in a multiple layers by further including second permanent magnets arranged on the outer side in the radial direction of the first permanent magnets, each of second permanent magnets is formed with a second flux barrier as the flux barrier adjacent to each circumferential end of the second permanent magnets; and in each magnetic pole, the central angle θ2 of a second arc portion composing the outer peripheral surface on the outer side in a radial direction of the rotor core, where flux barrier is not formed between the first flux barrier and the second flux barrier magnetic, is configured to ensure the first condition of θ2=P1×1.65 or less.

This increases the magnetic resistance between the first permanent magnet and the second permanent magnet→stator→magnetic pole, and disperses the magnetic flux linking the teeth, thereby alleviating local concentration of magnetic flux density and reducing stator iron loss.

In the rotary electric machine of this embodiment configured as described above, the central angle θ2 ensure the first condition of θ2=P1×1 or more.

This makes it possible to reduce stator iron loss and suppress a decrease in torque.

In the rotary electric machine of this embodiment configured as described above,
the first flux barrier extends to the outer side in a radial direction from both circumferential ends of the first permanent magnet at an extension angle θ3 set with respect to
the first permanent magnet, and the extension angle θ3 is adjusted to ensure the first condition.

By adjusting the extension angle θ3 in this manner, it becomes easier to adjust θ1 and θ2 to ensure the first condition.

### Embodiment 2

Hereinafter, embodiment 2 of the present disclosure will be described focusing on difference from the above embodiment 1,with reference to the drawings. The same parts as those in the embodiment 1 are designated by the same reference numerals and the description thereof will be omitted.

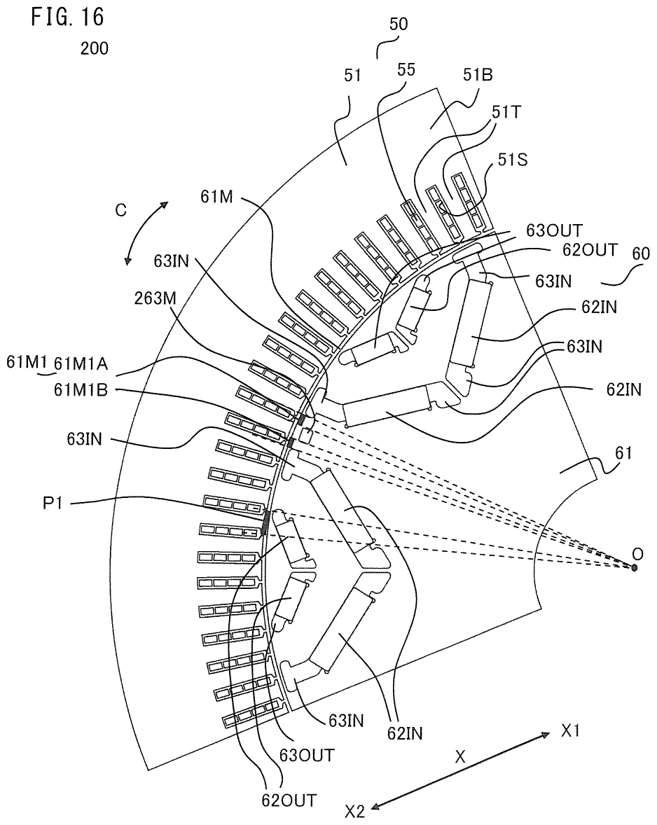

FIG. 16 is a diagram showing a part of a cross section perpendicular to the axial direction in a rotary electric machine 200 according to embodiment 2, and in this diagram, only a portion corresponding to approximately ¼ of the circumference of the annular rotary electric machine 200 is shown.

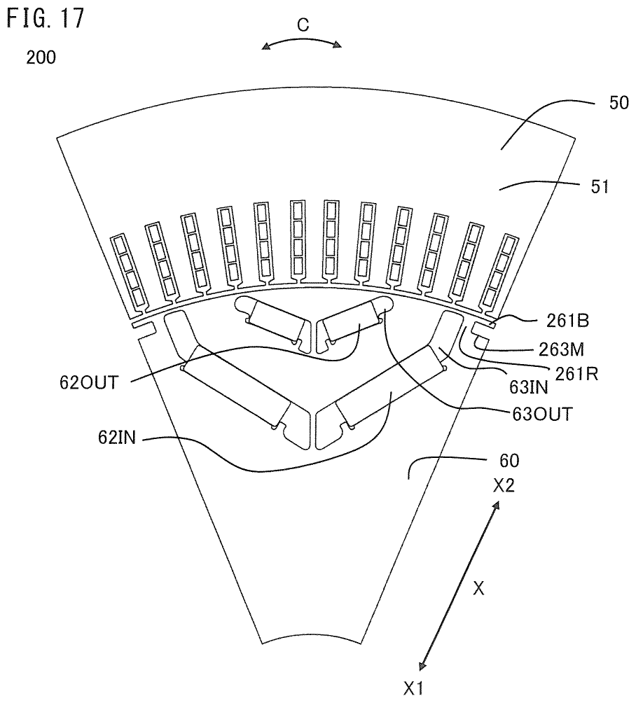

FIG. 17 is a partially enlarged cross-sectional view of the rotary electric machine 200 in FIG. 16, illustrating an example in which the shape of the end portion on the radially outer side X2 of the flux barrier 63IN is different.

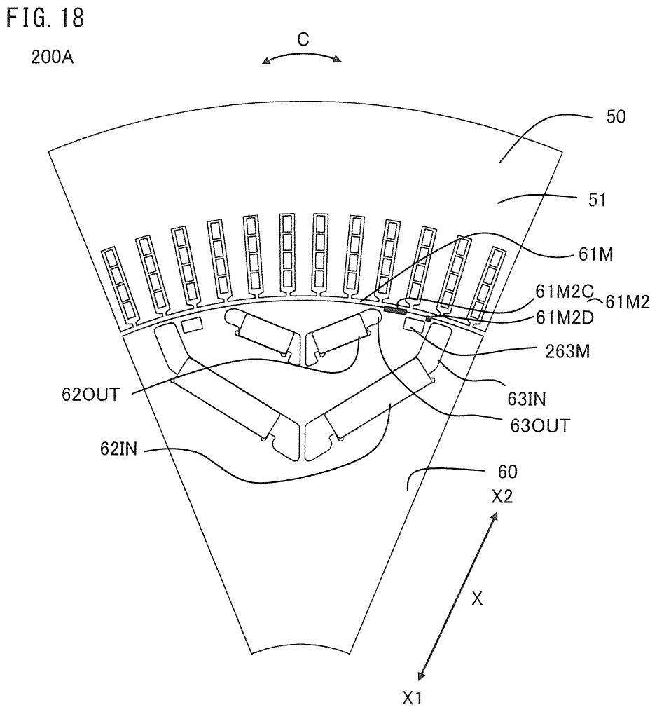

FIG. 18 is a diagram showing a part of a cross section perpendicular to the axial direction in a rotary electric machine 200A according to embodiment 2.

In the rotary electric machines 200 and 200A of this embodiment, a flux barrier 263M is provided as a third flux barrier that is not connected to the flux barriers 63IN and 63OUT and is configured independently near the outer circumferential surface 61M of the rotor core 61 between each magnetic pole.

In the rotary electric machine 200 shown in FIG. 16, the first arc portion 61M1 constituting θ1 is defined, by subtracting the circumferential length of the flux barrier 263M from the arc length of the rotor core 61 between adjacent flux barriers 63IN between each magnetic pole minus. In other words, the first arc portion 61M1 in the rotary electric machine 200 of this embodiment is the sum of the arcs 61M1A, 61M1B composing the outer peripheral surface of the radially outer side X2 of the rotor core 61 where no flux barrier 263M is formed, between the flux barriers 63IN between adjacent magnetic poles in the circumferential direction C.

Also, as in the rotary electric machine 200A shown in FIG. 18, the flux barrier 263M as the third flux barrier may be formed between one side in the circumferential direction C of the flux barrier 63OUT at each magnetic pole and the other side in the circumferential direction C of the flux barrier 63IN.

In this case, the second arc portion constituting θ2 is defined as the second arc portion 61M2 obtained by subtracting the circumferential length of the flux barrier 263M from the arc length of the outer circumferential surface 61M of the rotor core 61 between the flux barrier 63OUT and the flux barrier 63IN.

In other words, the second arc portion 61M2 in this embodiment is the sum of the arcs 61M2C, 61M2D that compose the outer circumferential surface of the rotor core 61 on the radially outer side X2 where the flux barrier 263M between the flux barrier 63OUT and the flux barrier 63IN is not formed.

In this way, by arranging the independent flux barrier 263M, the parameters that can change the rotor's permeance, magnetomotive force, etc. can be increased, and the degree of freedom in design can be expanded. For example, by adjusting the position, shape, etc. so as to cancel out the fluctuation of the excitation magnetic flux of the stator 50, the torque ripple can be reduced.

Furthermore, an extremely large flux barrier increases the stress on the bridge portion 261B shown in FIG. 17 between the flux barrier of the rotor and the outer circumferential surface 61M at high rotation speeds, and there is a concern that the centrifugal force resistance strength will decrease. Even in such a case, by arranging the independently formed flux barrier 263M, the rib 261R shown in FIG. 17 is formed between the flux barriers, and the stress on the bridge portion 261B can be dispersed to the rib 261R. This contributes to improving the centrifugal force resistance strength.

In order to prevent deformation of the rotor core 61 due to centrifugal force, it is possible to widen the width of the radial direction X of the bridge portion 261B to relieve the stress on the bridge portion 261B. However, increasing the width of the bridge portion 261B leads to a decrease in torque due to an increase in leakage flux. Therefore, in order to achieve high torque while ensuring centrifugal force resistance, it is necessary to set the width of the bridge portion 261B in the radial direction X as narrow as possible, for example, to 2% or less of the rotor diameter. On the other hand, if the width of the bridge portion 261B is made too narrow, magnetic flux will easily flow into the stator core 51, leading to an increase in stator iron loss, so the width of the bridge portion 261B in the radial direction X may be set to 2% or less of the rotor diameter and the value may be further adjusted.

Below, further modified examples in which the position of the flux barrier 263M is adjusted are shown.

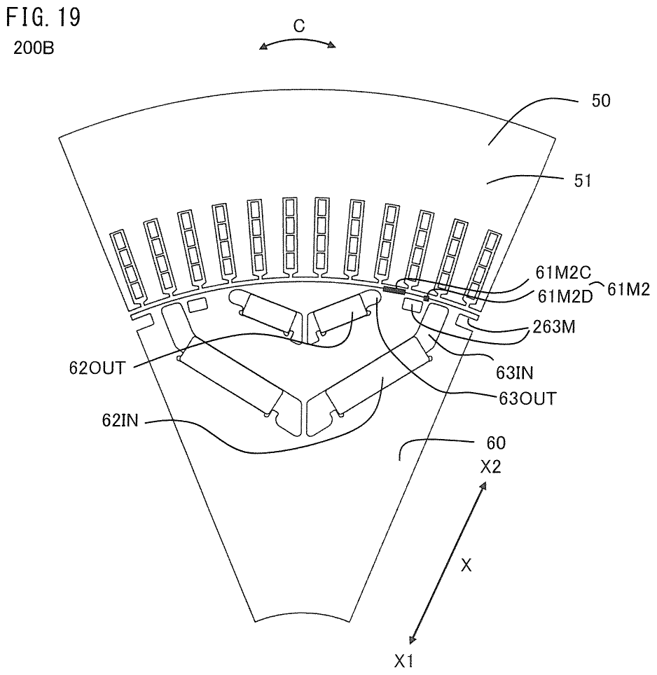

FIG. 19 shows a part of a cross section perpendicular to the axial direction of a rotary electric machine 200B according to embodiment 2.

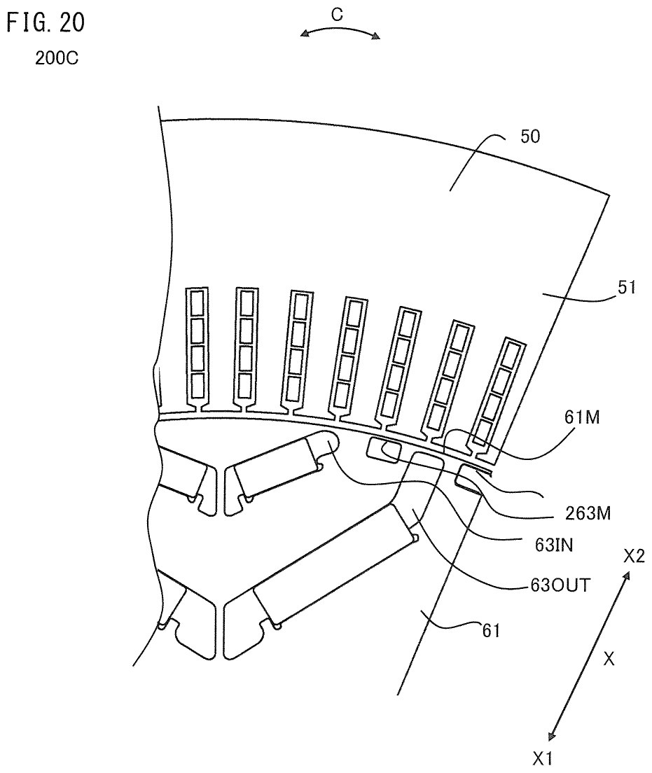

FIG. 20 shows a part of a cross section perpendicular to the axial direction of a rotary electric machine 200C according to embodiment 2.

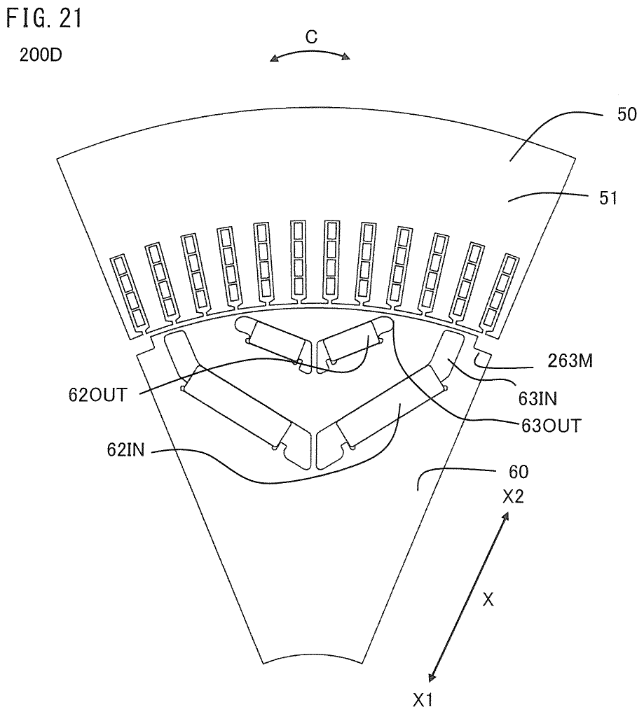

FIG. 21 shows a part of a cross section perpendicular to the axial direction of a rotary electric machine 200D according to embodiment 2.

As shown in FIG. 19, the flux barriers 263M may be arranged both between adjacent flux barriers 63IN in the circumferential direction C, and between the flux barriers 63OUT and 63IN at each magnetic pole.

Also, as shown in FIG. 20, a more effective configuration is one in which the radially outermost X2 portion of the flux barrier 263M is disposed radially outwardly X2 from the radially outermost X2 portions of the flux barriers 63IN, 63OUT.

If the distance between the flux barrier 263M and the outer peripheral surface 61M of the rotor core 61 is long, magnetic flux is more likely to short-circuit between the flux barrier 263M and the outer peripheral surface 61M, and the function as a flux barrier is reduced. Therefore, by configuring the flux barrier 263M to be closer to the outer peripheral surface 61M of the rotor core 61, as in the rotary electric machine 200C of FIG. 20, the function as a flux barrier is improved and the effect of reducing iron loss is increased.

Furthermore, as shown in FIG. 21, the flux barrier 263M may be arranged on the outer peripheral surface 61M side of the rotor core 61 so as to cut out the outer peripheral surface 61M on the radially outer side X2 of the rotor core 61.

In this case, the effect of providing the flux barrier 263M described above can be similarly obtained.

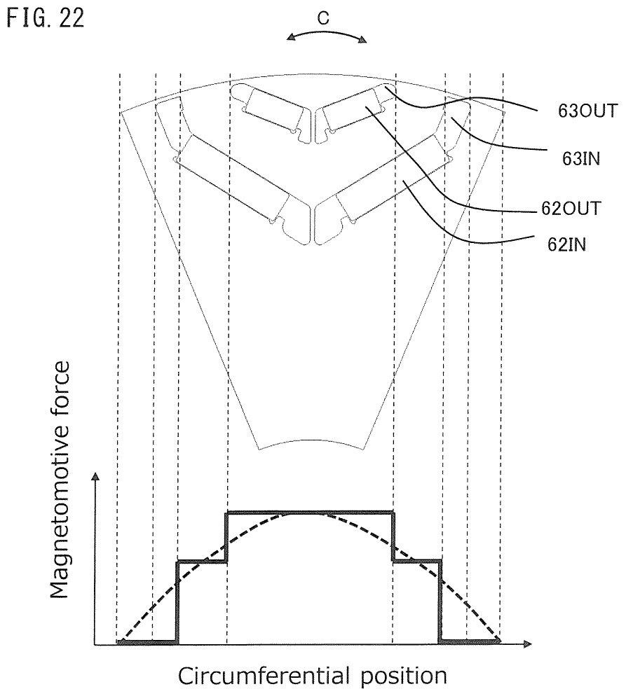

FIG. 22 is a diagram showing the magnetomotive force distribution in a rotary electric machine configured without a flux barrier 263M.

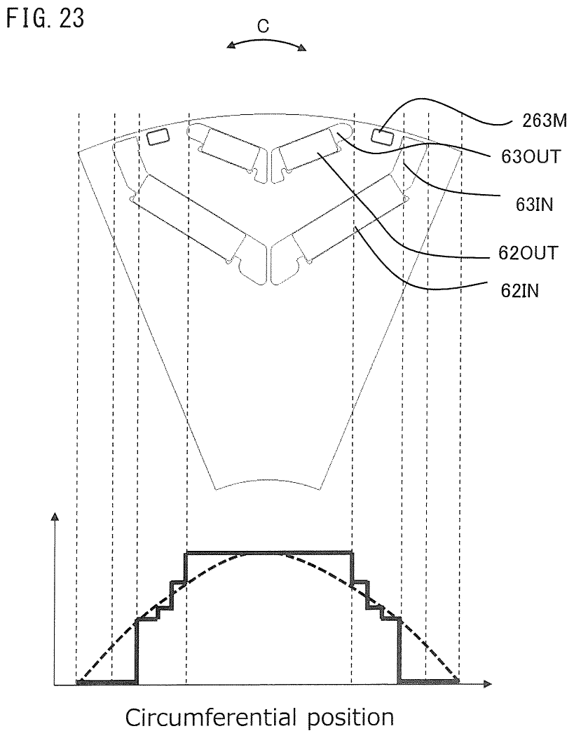

FIG. 23 is a diagram showing the magnetomotive force distribution in a rotary electric machine with the flux barrier 263M provided.

As shown in FIGS. 22 and 23, by providing the flux barrier 263M and adjusting its placement position, it is possible to adjust the magnetomotive force distribution of the rotor 60 to be closer to a sine wave, thereby reducing torque ripple.

The rotary electric machine of this embodiment configured as described above further includes:
a third flux barrier as the flux barrier, formed independently from the first flux barriers and second flux barriers,
wherein:
the third flux barrier is arranged in at least one of the spaces between one circumferential side of the second flux barrier and the other circumferential side of the first flux barrier in each magnetic pole, or between the first flux barriers of adjacent magnetic poles in the circumferential direction;
the first arc portion is the sum of arcs composing the outer peripheral surface on the outer side in a radial direction of the rotor core, where the third flux barrier is not formed between adjacent magnetic poles in the circumferential direction; and
the second arc portion is the sum of arcs composing the outer peripheral surface on the outer side in a radial direction of the rotor core, where the third flux barrier is not formed between the first flux barrier and the second flux barrier in each magnetic pole.

In this way, by providing a third flux barrier and configuring the central angle θ2 to ensure the first condition, it is possible to reduce torque ripple and improve centrifugal force resistance while mitigating local concentration of magnetic flux density in the teeth, reducing stator iron loss and making the rotary electric machine more efficient.

Furthermore, in the rotary electric machine of this embodiment configured as described above, the third flux barrier is arranged so that the magnetomotive force distribution of the rotor approaches a sinusoidal wave. This results in a quieter rotary electric machine with reduced torque ripple.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

50 Stator, 51 Stator core, 51B York portion, 51T Teeth, 51S Slot, 61 Rotor core (rotor core), 621N permanent magnet (first permanent magnet), 62OUT permanent magnet (second permanent magnet), 63IN flux barrier (first flux barrier), 263M third flux barrier (flux barrier), 55 Coil (armature windings), 100, 100A, 100B, 200A, 200B, 200C, 200D Rotary electric machine.

1. A rotary electric machine comprising:
a stator having a plurality of teeth protruding to an inner side in a radial direction from an annular yoke portion, and armature windings wound in a plurality of slots formed between the teeth; and
a rotor including a rotor core having a plurality of magnetic poles and flux barriers, the poles being formed of permanent magnets, wherein
in the rotary electric machine, the number of the slots for each phase and each pole obtained by dividing a total number of slots by a number of phases and a number of the magnetic poles of the rotor is four or more, and the armature winding is configured as distributed winding, and wherein:
a first flux barrier as the flux barrier is formed adjacent to each circumferential end of a first permanent magnet composing each of the magnetic poles;
a central angle θ1 of a first arc portion composing an outer peripheral surface on an outer side in a radial direction of the rotor core, where flux barrier is not formed between magnetic poles adjacent in the circumferential direction, is configured to ensure a first condition of θ1=P1×2.1 or less.
where P1 is a central angle of an arc connecting the circumferential centers of circumferentially adjacent slots.

2. The rotary electric machine according to claim 1, wherein:
the magnetic poles is configured in a multiple layers by further including second permanent magnets arranged on the outer side in the radial direction of the first permanent magnets, each of second permanent magnets is formed with a second flux barrier as the flux barrier adjacent to each circumferential end of the second permanent magnets; and
in each magnetic pole, the central angle θ2 of a second arc portion composing the outer peripheral surface on the outer side in a radial direction of the rotor core, where flux barrier is not formed between the first flux barrier and the second flux barrier magnetic, is configured to ensure the first condition of θ2=P1×1.65 or less.

3. The rotary electric machine according to claim 2, wherein, the central angle θ2 ensure the first condition of θ2=P1×1 or more.

4. The rotary electric machine according to claim 2, wherein,
the first flux barrier extends to the outer side in a radial direction from both circumferential ends of the first permanent magnet at an extension angle θ3 set with respect to the first permanent magnet, and the extension angle θ3 is adjusted to ensure the first condition.

5. The rotary electric machine according to claim 2, further comprising,
a third flux barrier as the flux barrier, formed independently from the first flux barriers and second flux barriers, wherein:
the third flux barrier is arranged in at least one of the spaces between one circumferential side of the second flux barrier and the other circumferential side of the first flux barrier in each magnetic pole, or between the first flux barriers of adjacent magnetic poles in the circumferential direction;
the first arc portion is the sum of arcs composing the outer peripheral surface on the outer side in a radial direction of the rotor core, where the third flux barrier is not formed between adjacent magnetic poles in the circumferential direction; and
the second arc portion is the sum of arcs composing the outer peripheral surface on the outer side in a radial direction of the rotor core, where the third flux barrier is not formed between the first flux barrier and the second flux barrier in each magnetic pole.

6. The rotary electric machine according to claim 5, wherein,
the third flux barrier is arranged so that the magnetomotive force distribution of the rotor approaches a sinusoidal wave.

7. The rotary electric machine according to claim 5, wherein,
the outer portion in a radial direction of the third flux barrier is arranged on the outer side in a radial direction of the outer portion in a radial direction of the first and second flux barriers.

8. The rotary electric machine according to claim 5, wherein,
the third flux barrier is arranged at the outer peripheral side of the rotor core so as to cut out the outer side in a radial direction of the rotor core.

9. The rotary electric machine according to claim 2, wherein,
the magnetic poles with a multiple layer are configured as a two-layer comprising the first flux barrier forming a first layer and the second flux barrier forming a second layer.

10. The rotary electric machine according to claim 2, wherein,
the magnetic poles with a multiple layer are configured as a three-layer or more comprising the first flux barrier forming a first layer and the plurality of second flux barriers forming subsequent layers.

11. The rotary electric machine according to claim 2, wherein,
at least one of bridge portions formed between the first and second flux barriers and the outer peripheral surface of the rotor core has a radial width of 2% or less of the rotor diameter.

12. The rotary electric machine according to claim 2, wherein,
the first and second permanent magnets are configured with a pair of magnets arranged in a V-shape opening toward the outer peripheral side of the rotor.

13. The rotary electric machine according to claim 1, wherein,
the number of magnetic poles is configured as six or more poles.

14. The rotary electric machine according to claim 3, wherein,
the first flux barrier extends to the outer side in a radial direction from both circumferential ends of the first permanent magnet at an extension angle θ3 set with respect to the first permanent magnet, and the extension angle θ3 is adjusted to ensure the first condition.

15. The rotary electric machine according to claim 3, further comprising,
a third flux barrier as the flux barrier, formed independently from the first flux barriers and second flux barriers, wherein:
the third flux barrier is arranged in at least one of the spaces between one circumferential side of the second flux barrier and the other circumferential side of the first flux barrier in each magnetic pole, or between the first flux barriers of adjacent magnetic poles in the circumferential direction;
the first arc portion is the sum of arcs composing the outer peripheral surface on the outer side in a radial direction of the rotor core, where the third flux barrier is not formed between adjacent magnetic poles in the circumferential direction; and
the second arc portion is the sum of arcs composing the outer peripheral surface on the outer side in a radial direction of the rotor core, where the third flux barrier is not formed between the first flux barrier and the second flux barrier in each magnetic pole.

16. The rotary electric machine according to claim 4, further comprising,
a third flux barrier as the flux barrier, formed independently from the first flux barriers and second flux barriers, wherein:
the third flux barrier is arranged in at least one of the spaces between one circumferential side of the second flux barrier and the other circumferential side of the first flux barrier in each magnetic pole, or between the first flux barriers of adjacent magnetic poles in the circumferential direction;
the first arc portion is the sum of arcs composing the outer peripheral surface on the outer side in a radial direction of the rotor core, where the third flux barrier is not formed between adjacent magnetic poles in the circumferential direction; and
the second arc portion is the sum of arcs composing the outer peripheral surface on the outer side in a radial direction of the rotor core, where the third flux barrier is not formed between the first flux barrier and the second flux barrier in each magnetic pole.

17. The rotary electric machine according to claim 14, further comprising,
a third flux barrier as the flux barrier, formed independently from the first flux barriers and second flux barriers, wherein:
the third flux barrier is arranged in at least one of the spaces between one circumferential side of the second flux barrier and the other circumferential side of the first flux barrier in each magnetic pole, or between the first flux barriers of adjacent magnetic poles in the circumferential direction;
the first arc portion is the sum of arcs composing the outer peripheral surface on the outer side in a radial direction of the rotor core, where the third flux barrier is not formed between adjacent magnetic poles in the circumferential direction; and
the second arc portion is the sum of arcs composing the outer peripheral surface on the outer side in a radial direction of the rotor core, where the third flux barrier is not formed between the first flux barrier and the second flux barrier in each magnetic pole.

18. The rotary electric machine according to claim 15, wherein,
the third flux barrier is arranged so that the magnetomotive force distribution of the rotor approaches a sinusoidal wave.

19. The rotary electric machine according to claim 16, wherein,
the third flux barrier is arranged so that the magnetomotive force distribution of the rotor approaches a sinusoidal wave.

20. The rotary electric machine according to claim 17, wherein,
the third flux barrier is arranged so that the magnetomotive force distribution of the rotor approaches a sinusoidal wave.
